(19) United States
(12) Patent Application Publication
(10) Pub. No.: US 2021/0037730 A1
(43) Pub. Date: Feb. 11, 2021

(54) Hydroponic System Module

(71) Applicant: Hally Hofmeyr, Philadelphia, PA (US)

(72) Inventor: Maksim Liberman, Philadelphia, PA (US)

(21) Appl. No.: 16/537,541

(22) Filed: Aug. 10, 2019

(51) Int. Cl. A01G 31/00

(52) U.S. Cl. CPC A01G 31/00; A01G 2031/006

(57) ABSTRACT

The present disclosure provides means for growing plants and can be used in the cultivation of plants in a nutrient medium without soil using hydroponics. The module includes a housing with a landing extension, an aperture for planting plants and an outlet for draining excess water and nutrients. Landing expansion contains a thread on the inside of the landing expansion and a stopper for fixing the screwing in the thread during installation. In the inner part of the body has a main drainage. For the bottom of the main drainage is adjacent at least one support for the main drainage. External thread is provided on the outer part of the outlet, the depth and pitch of which are commensurate with the depth and step of the internal thread in the seating expansion.

### FIELD OF THE INVENTION

The present disclosure provides means for growing plants and can be used in the cultivation of plants in a nutrient medium without soil using hydroponics.

### BACKGROUND

From the prior art a device for growing plants without soil on a vertical surface, described in the Russian Federation patent RU 2163755 C1, is known, which contains a system for supplying plants with water and nutrients in the form of a vertically installed wall of hollow tubes, means for irrigation and modular elements, providing installation, care of crops and plant renewal. The irrigation product has a tank, a pump, a control unit and a distribution tube. The modules are located in apertures for attachment of modular elements and the receipt of water and nutrients to the plants of a vertically mounted wall with the possibility of their installation and removal. Each module contains a housing with an inlet and an outlet tube. The inlet tube is arranged at an angle with respect to the housing and has an oblique slant striving towards the horizon line and intended for a more complete penetration of water into the tube. In this case, the side of the inlet tube located first in the course of a liquid medium consisting of water and nutrients is less than the second side of the inlet tube having a fixing protrusion. The outlet tube is located at right angles to the body and has an oblique slice to facilitate the drainage task. The side, located first in the course of a liquid medium, consisting of water and nutrients, is larger than the second side of the outlet tube, having a fixing protrusion. The fixing protrusions are intended for fastening of modular elements in apertures of a wall. Apertures in hollow tubes are arranged at intervals corresponding to tube modules.

A disadvantage of the known solution is its low reliability of the device design for growing plants without land on the vertical surface as a whole. In particular, it is necessary to take into account the need for preventive cleaning in the case of attachment of modules to tubes. Particles of the root system or leaves of plants, falling into the modules, prevent the free flow of water and nutrients, which leads to loss of yield. It is possible to eliminate this defect by removing the modules from the tube. At the same time, the fixing protrusion and other fastening elements of the module are damaged, which leads to the flow of the system in the places where the damaged elements interfere. Thus, there is a need to create a hydroponic system module that is easy to maintain and reliable in operation.

### SUMMARY OF THE INVENTION

The problem is solved by the fact that the hydroponic system module of the present disclosure has a vertical orientation of the installation and includes a housing with a landing extension for receiving water and nutrients for plants, a planting aperture and an outlet for removing excess water and nutrients. The module has a vertical orientation of the installation. The landing expansion includes a thread on the inside of the seating expansion and a stopper for fixing the threading of the thread during mounting. In the inner part of the housing there is a main drain, attached to the inner wall of the body at an angle. At least one support for the main drainage system is adjacent to the bottom of the main drainage pipe. The planting aperture is located at an acute angle to the vertical axis of the housing. On the outer part of the outlet there is an outer thread, the depth and pitch of which are commensurate with the depth and step of the internal thread in the landing expansion. The internal diameter of the landing expansion is commensurate with the outer diameter of the outlet.

According to an embodiment of the module, a stopper for fixing the screwing is formed in the landing extension.

The manifested technical result is the ability to adapt the hydroponic system, consisting of the declared modules, to the installation site. This property is possible due to the fact that the modules are connected to each other to a pre-set desired height. The connected modules in the vertical orientation are both the landing elements and the bearing structure.

### BRIEF DESCRIPTION DRAWINGS

The essence of the claimed invention is illustrated in the accompanying drawings. The drawings are such that they do not restrict the execution of the claimed object and include all possible embodiments covered by the claims.

FIG. 1. shows a general view of the module.

FIG. 2. shows a top view of the module.

FIG. 3 shows the module in section along the vertical axis.

FIG. 4. shows another view of the module in section along the vertical axis.

FIG. 5 shows a sectional view of the module along the vertical axis in isometric view.

FIG. 6 shows another module view in section along the vertical axis in isometry.

### DETAILED DESCRIPTION DRAWINGS

Next, the operating principle of the claimed module will be shown with reference to the accompanying drawings.

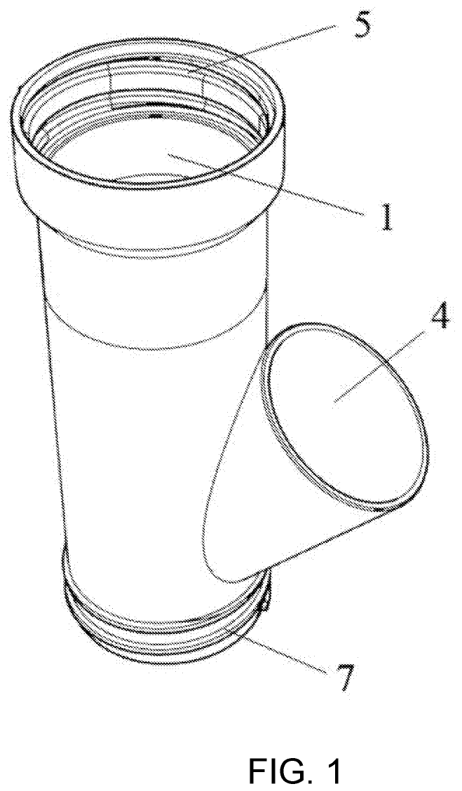

FIG. 1 shows that a landing extension (1) is located at the top of the module. Landing expansion mainly has a circular cross-section predominantly. This structure allows the inner thread (5) to be placed on the inside of the seating expansion. At the bottom of the module is an outlet, the outer part of which has an outer thread (7). The internal thread (5) and the outer thread (7) ensure that the modules are twisted into each other. Advantageously, the width of the inner thread is less than the seating expansion. This makes it easier to connect the two modules, since it is not necessary to look for the beginning of the threads for screwing.

In the side of the housing there is an aperture for planting plants (4), which extend as a glass at an acute angle relative to the vertical axis of the module. The dimensions and position of this planting aperture (4) are selected for existing glasses for hydroponic systems. Location of glass in the module due to the design of the planting aperture (4) is chosen to maximize the ingress of irrigation water for the root system.

When planting a plant in a planting aperture (4), the root system hangs in the air and water gets to the roots by means free fall. That is, the hydroponic system, consisting of the declared modules, allows plants to grow using an airport method. This design alleviates a need for spray guns, thus simplifying the design of the system.

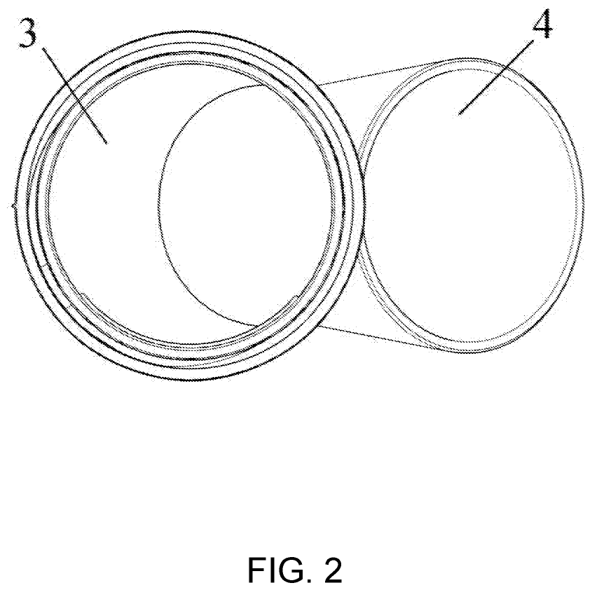

FIG. 2 shows a module view from above. From this position, the main drainage system (3) is located in the inside of the housing. The main drainage system is designed to drain the water stream towards the root system of the plant. Thus, water that does not come directly onto the plant collects along the walls and is again allocated to the next plant and provides optimal watering for all plants in the system. FIG. 2 further illustrates that the plant aperture does not have a prolongation to the inside of the module housing.

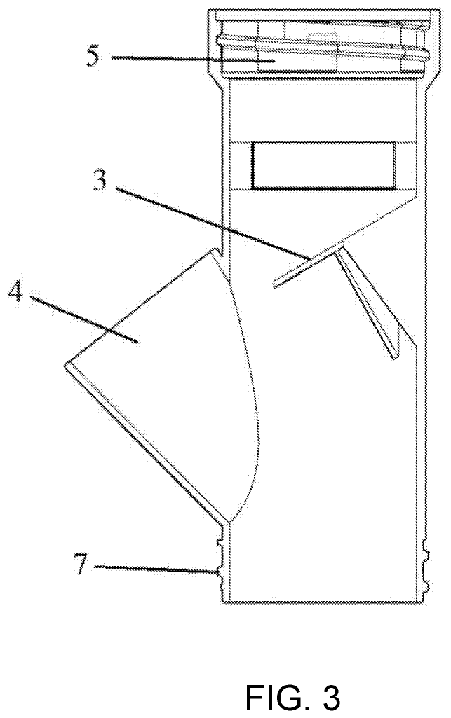

FIG. 3 shows that the main drainage pipe (3) forms an obtuse angle with the inner wall of the housing. This arrangement of the main drainage system ensures uniform flow of water to the root systems of all plants.

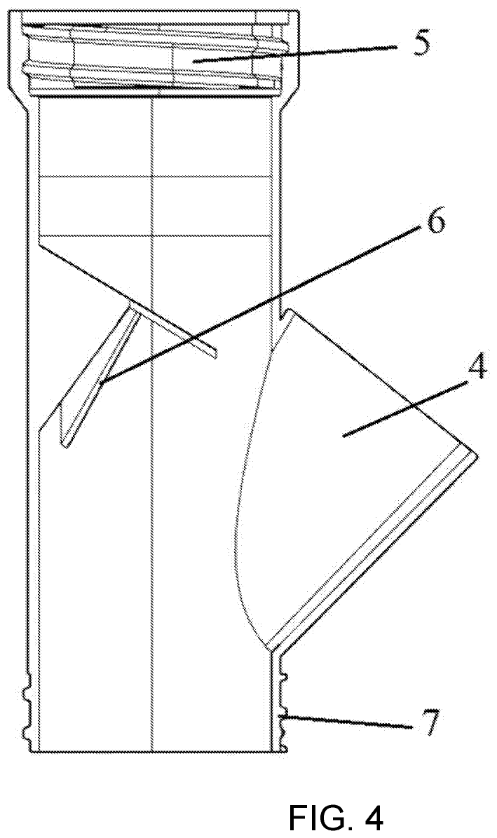

In FIG. 4 shows that support (6) for the main drainage (3) adjoins the lower part of the main drainage (3). Support (6) prevents the deflection of the main drainage ( ) from the water by the action of the water falling on it. This structure may be required to ensure the strength of the drainage structure when pulling the root system of plants, as well as for the strength of the drainage system itself.

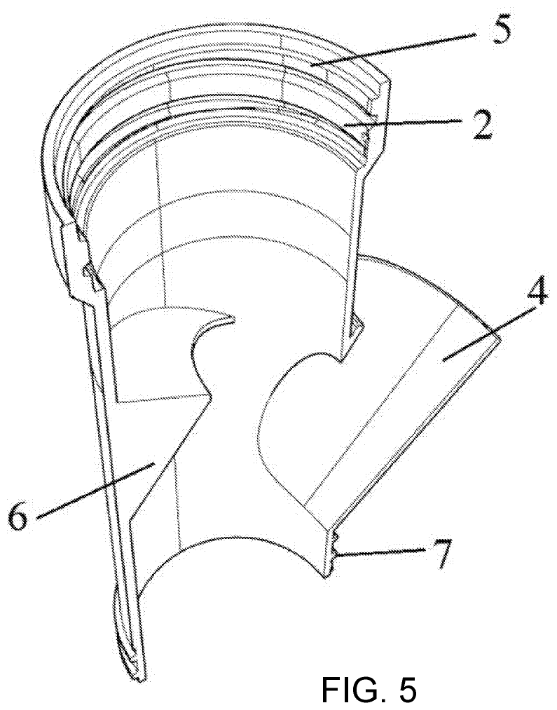

FIG. 5 shows the presence of a. stopper (2) in the inner thread for fixing the threading of the outlet opening. The stopper for fixing thread twist provides fixation when inverting the modules for their clear vertical and identical arrangement.

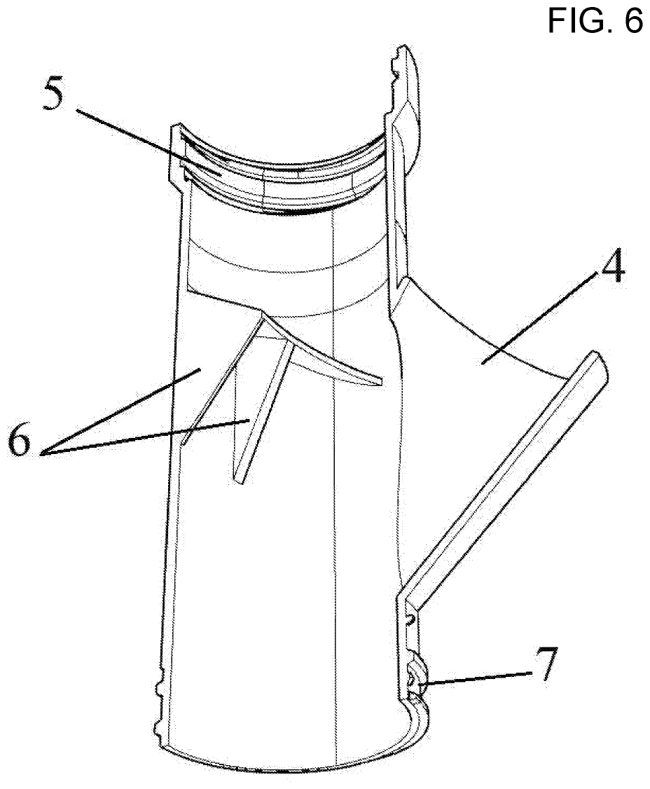

FIG. 6 best describes the location of support for the main drainage system. Support for the main drainage system forms the edge of the rigidity in which the main drainage rests.

For the manufacture of the module, acrylonitrile butadiene styrene (ABS, ABS) or impact-resistant polystyrene (HIPS plastic) is used.

Manufacturing of this module is possible with the help of prototyping systems, that is, 3D printing on the printer. When manufacturing a module,

a) a printer using Fused Deposition Modeling (FDM) is used;

b) a printer using Selective Laser Sintering (SLS) technology. Programs that can work with GCODE can be used as software, for example: CURA, Slicer, S3D.

With the aid of the claimed module, many small leafy greens, such as lettuce, cabbage, basil, parsley, etc. can be grown. The radius of the crown is 15 to 20 cm.

As material for plant planting, predominantly, but not necessarily, it is recommended to use either 1 inch cubic of mineral wool or insert from other materials (soil, substrates, any artificial materials).

In order that the material in which the plant grows does not contaminate the system, a filter system of the purification system is provided (not shown in the drawing). However, in order that the material in which the plant grows does not contaminate the system, it is preferable to use insoluble solutions, which are non-soil mixtures and/or insoluble materials (mineral wool cubes).

The module allows for the following differences and advantages for hydroponic systems, consisting of several claimed modules, from known solutions:

1) do not use soil

2) module system—this is a hybrid system of aeroponics and Nutrient film technique (NFT)

3) the module connection allows the creation of a vertical system without sprayers of an aqueous mixture rich in nutrients, sprays and diffusers.

The module provides plant growth as follows:

1. The cube is placed in a growing bowl with a. top diameter of 5.08 cm.

2. The growing bowl is placed in the side hole in the module,

3. A constant supply of aqueous mixture with nutrients to the plant roots is activated the ripening of the plants).

Thus, the task is completed and new technical advantages of the claimed module appear. Those person skilled in the art will appreciate improvements within the scope of the disclosed inventive description disclosed herein.

### THE LIST OF POSITIONS ON THE DRAWINGS

1—Landing expansion
2—Stopper for fixing the screwing in the thread
3—Main drainage
4—Planting aperture
5—Internal thread in seating expansion
6—Support for main drainage.
7—External thread on the outlet

1. A hydroponic system module, which has a vertical orientation of the installation, and includes a housing with a landing extension for receiving water and nutrients for plants,
wherein
the body further comprises a planting hole and an outlet for removing excess water and nutrients
moreover, the landing extension contains a thread on the inner side of the landing expansion and a stopper for fixing the threading during installation,
housing in the inner part of the has a main drainage system, attached to the inner wall of the housing at an angle,
for the bottom of the main drainage is adjacent at least one support for the main drainage,
the plant aperture is located at an acute angle to the vertical axis of the housing,
an external thread is provided on the outer part of the outlet, the depth and pitch of which are commensurate with the depth and step of the internal thread in the seating expansion,
and the internal diameter of the landing extension is commensurate with the outer diameter of the outlet.

2. The hydroponic system module according to claim 1, wherein a stopper is formed in the landing extension for fixing the screwing in.
